(19) United States
(12) Patent Application Publication
(10) Pub. No.: US 2014/0191656 A1
(43) Pub. Date: Jul. 10, 2014

(54) MAGNETRON AND DEVICE USING MICROWAVES RELATED APPLICATIONS

(71) Applicant: Panasonic Corporation, Osaka (JP)

(72) Inventor: Takeshi ISHII, Shiga (JP)

(73) Assignee: Panasonic Corporation, Osaka (JP)

(21) Appl. No.: 14/148,271

(22) Filed: Jan. 6, 2014

(30) Foreign Application Priority Data
Jan. 9, 2013 (JP) 2013-001487

(51) Int. Cl. H01J 23/12; H01J 25/50

(52) U.S. Cl. CPC H01J 23/12; H01J 25/50
USPC 315/34

(57) ABSTRACT

The magnetron according to the present invention includes an anode portion, a cathode portion arranged in a central portion of the anode portion, an output antenna connected to the anode portion, an exhaust pipe arranged around the output antenna to serve as a part of a vacuum tube, and an antenna cap covering a chip-off portion included in the exhaust pipe. The antenna cap and the exhaust pipe are welded to each other.

### BACKGROUND OF THE INVENTION

1. Field of the Invention

The present invention relates to a magnetron used in a device using microwaves, such as a microwave oven and a thermotherapy device, and more particularly to a structure of a connecting portion of an exhaust pipe and an antenna cap.

2. Description of the Related Art

Conventionally, as a magnetron of this type, there has been known, for example, a structure shown in FIG. 4.

In FIG. 4, a conventional magnetron is provided with an anode portion 101, a cathode portion 102, an output portion 103, and an output antenna 104.

The anode portion 101 has a cylindrical anode cylinder 111, and a plurality of vanes 112 radially arranged inside the anode cylinder 111. The plurality of vanes 112 is electrically connected in an alternate manner to every other strap rings 113 having different diameters. In addition, an input side opening and an output side opening of the anode cylinder 111 are provided with pole pieces 114 and 115, respectively, for concentrating a magnetic field on a central portion of the anode cylinder 111.

The cathode portion 102 is arranged in a central portion of the anode portion 101, and is provided with a cathode filament 121 that emits thermal electrons. A lead wire 122 is connected to the cathode filament 121. The lead wire 122 passes through an inside of a side pipe 123 attached to the pole piece 114 on the input side, and then penetrates through a ceramic stem 124 provided so as to block the input side opening of the side pipe 123, to be connected to a connecting terminal 125.

The output portion 103 is provided with a side pipe 131 attached to the pole piece 115 on the output side, a cylindrical antenna ceramic 132 attached to the output side opening of the side pipe 131, and an exhaust pipe 133 attached to the output side opening of the antenna ceramic 132 to serve as a part of a vacuum tube.

The antenna 104 is connected to one of the plurality of vanes 112 of the anode portion 101. In addition, the antenna 104 passes through a hole 115a provided in the pole piece 115 of the output side, and then passes through insides of the side pipe 131 and the antenna ceramic 132 to be extended to an inside of the exhaust pipe 133. The exhaust pipe 133 has a chip-off portion 133a. After gas in the anode portion 101, the cathode portion 102, and the output portion 103 is exhausted, the chip-off portion 133a is formed by being pressure-bonded with the antenna 104 interposed therein and removing an unnecessary portion. Microwave energy generated in the anode portion 101 is extracted from the anode portion 101 with the antenna 104 connected to the one of vanes 112 to be emitted outside from the chip-off portion 133a.

The chip-off portion 133a formed in an edge shape is a portion which is easily damaged. Accordingly, as shown in FIGS. 5 and 6, an antenna cap 134 is attached so as to cover the chip-off portion 133a. The antenna cap 134 is fixed by being press-fitted to an outer circumferential surface of an end portion 133b serving as a connecting portion with the antenna ceramic 132 of the exhaust pipe 133.

Generally, the exhaust pipe 133 is made of oxygen-free copper, and the antenna ceramic 132 is made of ceramic. That is, the exhaust pipe 133 and the antenna ceramic 132 are made of materials having different thermal expansion coefficients. In addition, the exhaust pipe 133 and the antenna ceramic 132 are generally heated to 800° C. or more to be connected to each other by brazing. Therefore, the end portion 133b of the exhaust pipe 133 is brazed with the antenna ceramic 132 in an expanded state. On the other hand, the antenna ceramic 132 having a small thermal expansion coefficient does not contract so much even when it is cooled. Accordingly, the end portion 133b of the exhaust pipe 133 is formed in a tapered shape in which the diameter of the end portion 133b is larger on the side close to the antenna ceramic 132, and decreases with distance from the antenna ceramic 132.

When the magnetron is operated (ON), the temperature of the output portion 103 increases, for example, to about 300° C. On the other hand, when the magnetron is not operated (OFF), the temperature of the output portion 103 returns to a normal temperature. When switching ON/OFF of the magnetron is repeated, temperature fluctuations (so-called heat cycle) of the output portion 103 weaken the strength of a press-fitting portion of the antenna cap 134 and the exhaust pipe 133. In addition, because the end portion 133b of the exhaust pipe 133 is formed in a tapered shape, the antenna cap 134 is likely to be removed. When the antenna cap 134 is removed, the chip-off portion 133a is damaged, and it becomes impossible to suppress occurrence of failures, such as electric discharge, vacuum leakage, and the like.

As a structure for suppressing removal of the antenna cap 134, there have been known structures disclosed in, for example, Patent Document 1 (JP-A-08-185806) and Patent Document 2 (JP-A-2007-066673).

Patent document 1 discloses a magnetron in which a projection is provided on an inner circumferential surface of the antenna cap, and a concave groove is provided in an outer circumferential surface of the exhaust pipe, such that the projection of the antenna cap and the concave groove of the exhaust pipe are fitted to each other.

On the other hand, Patent document 2 discloses a magnetron in which the end portion of the exhaust pipe, to which the antenna cap is press-fitted, has a length ranging from 8 mm to 10 mm in a tubular axial direction.

### PATENT DOCUMENTS

Patent Document 1: JP-A-H08-185806

Patent Document 2: JP-A-2007-066673

### SUMMARY OF THE INVENTION

In the conventional magnetrons, generally, each portion thereof has been designed based on the assumption that the magnetrons have an oscillation frequency of 2.45 GHz band. In recent years, however, there has been developed a magnetron having an oscillation frequency of 5.8 GHz band. This is because, in the magnetron having the oscillation frequency of 5.8 GHz band, a wavelength of the oscillation frequency is approximately a half of that of the magnetron having an oscillation frequency of 2.45 GHz band, so that the sizes of peripheral devices, such as a waveguide and the like, are approximately halved to allow the peripheral devices to be greatly reduced in size.

In the magnetron having the oscillation frequency of 5.8 GHz band, it is necessary to reduce a length of the end portion (outer circumferential surface) of the exhaust pipe in the tubular axial direction (e.g., from 10 mm to 5 mm). In this case, since a press fit length of the antenna cap and the exhaust pipe becomes short, the structures of Patent documents 1 and 2 cannot fully suppress removal of the antenna cap.

As a method of solving this problem, there can be considered, for example, a structure in which the antenna cap and the exhaust pipe are bonded with a conductive adhesive, such as a silver paste or the like. However, in this structure, under a condition of heat cycle caused by repeating switching ON/OFF of the magnetron, it is difficult to continuously maintain the adhesive strength between the antenna cap and the exhaust pipe.

Therefore, an object of the present invention is to solve the conventional problem described above, and to provide a magnetron which can suppress removal of the antenna cap.

In order to achieve the above described object, the magnetron according to the present invention includes an anode portion, a cathode portion arranged in a central portion of the anode portion, an output antenna connected to the anode portion, an exhaust pipe arranged around the output antenna to serve as a part of a vacuum tube, and an antenna cap covering a chip-off portion included in the exhaust pipe, wherein the antenna cap and the exhaust pipe are welded to each other.

The magnetron according to the present invention can further reliably suppress the removal of the antenna cap, since the antenna cap and the exhaust pipe are welded to each other.

### BRIEF DESCRIPTION OF THE DRAWINGS

These and other aspects and features of the present invention will become clear from the following description taken in conjunction with the preferred embodiments thereof with reference to the accompanying drawings, in which:

FIG. 1 is a longitudinal sectional view of a magnetron according to an embodiment of the present invention.

FIG. 2 is a partially enlarged sectional view showing a structure of the vicinity of an antenna cap included in the magnetron shown in FIG. 1.

FIG. 3 is a perspective view showing a structure of the vicinity of an antenna cap included in the magnetron shown in FIG. 1.

FIG. 4 is a longitudinal sectional view of a conventional magnetron.

FIG. 5 is a partially enlarged sectional view showing a structure of the vicinity of an antenna cap included in the magnetron shown in FIG. 4.

FIG. 6 is a perspective view showing a structure of the vicinity of an antenna cap included in the magnetron shown in FIG. 4.

### DETAILED DESCRIPTION OF THE PREFERRED EMBODIMENTS

According to a first aspect of the present invention, there is provided a magnetron including: an anode portion, a cathode portion arranged in a central portion of the anode portion, an output antenna connected to the anode portion, an exhaust pipe arranged around the output antenna to serve as a part of a vacuum tube, and an antenna cap covering a chip-off portion included in the exhaust pipe, wherein the antenna cap and the exhaust pipe are welded to each other.

According to a second aspect of the present invention, there is provided the magnetron according to the first aspect, wherein a sidewall of the antenna cap includes at least a hole, a peripheral portion of the hole and exhaust pipe are welded.

According to a third aspect of the present invention, there is provided the magnetron according to the first aspect, wherein a sidewall of the antenna cap includes three or more holes arranged in an equal pitch, each peripheral portion of the holes and exhaust pipe are welded.

According to a fourth aspect of the present invention, there is provided the magnetron according to any one of the first to third aspects, wherein the magnetron has an oscillation frequency of 5.8 GHz band.

According to a fifth aspect of the present invention, there is provided the magnetron according to the fourth aspect, wherein shapes of the inner circumferential surface of the antenna cap and the outer circumferential surface of the exhaust pipe match with each other.

According to a sixth aspect of the present invention, there is provided the magnetron according to the fourth aspect, wherein the inner circumferential surface of the antenna cap and the outer circumferential surface of the exhaust pipe have a cylindrical shape.

According to a seventh aspect of the present invention, there is provided a device using microwaves comprising the magnetron according to any one of the first to sixth aspects.

Hereinafter, an embodiment of the present invention will be described with reference to the drawings. It should be noted that the present invention is not limited to this embodiment.

### Embodiment

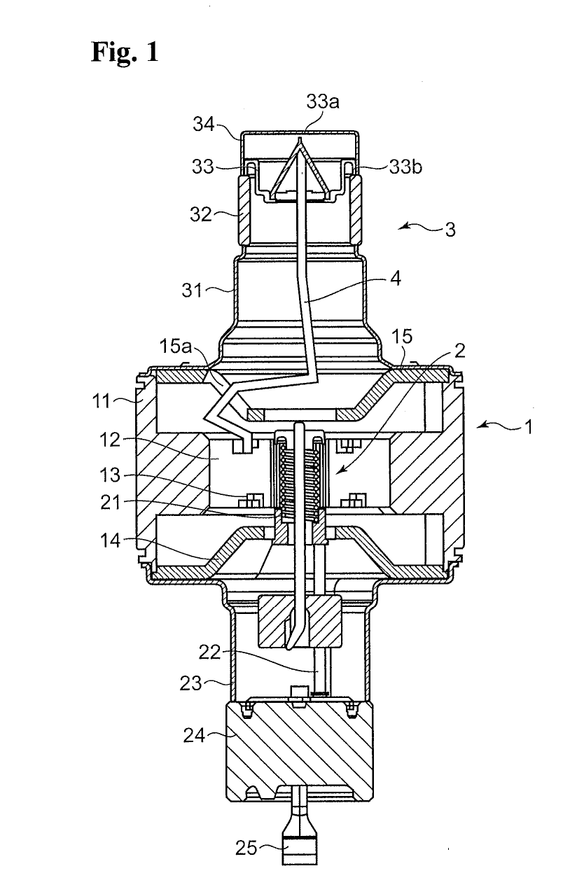

A description will be given of a magnetron according to an embodiment of the present invention. The magnetron according to the present embodiment is used in a device using microwaves, such as a microwave oven and a thermotherapy device. FIG. 1 is a longitudinal sectional view showing an overall structure of the magnetron according to the present embodiment.

As shown in FIG. 1, the magnetron according to the present embodiment is provided with an anode portion 1, a cathode portion 2, an output portion 3, and an output antenna 4.

The anode portion 1 has a cylindrical anode cylinder 11, and a plurality of vanes 12 radially arranged inside the anode cylinder 11. The plurality of vanes 12 is electrically connected in an alternate manner to every other strap rings 13 having different diameters. In addition, an input side opening and an output side opening of the anode cylinder 11 are provided with pole pieces 14 and 15, respectively, for concentrating a magnetic field on a central portion of the anode cylinder 11.

The cathode portion 2 is arranged in a central portion of the anode portion 1, and is provided with a cathode filament 21 that emits thermal electrons. A lead wire 22 is connected to the cathode filament 21. The lead wire 22 passes through an inside of a side pipe 23 attached to the pole piece 14 on the input side, and then penetrates through a ceramic stem 24 provided so as to block the input side opening of the side pipe 23, to be connected to a connecting terminal 25.

The output portion 3 is provided with a side pipe 31 attached to the pole piece 15 on the output side, a cylindrical antenna ceramic 32 attached to the output side opening of the side pipe 31, and an exhaust pipe 33 attached to the output side opening of the antenna ceramic 32 to serve as a part of a vacuum tube.

The antenna 4 is connected to one of the plurality of vanes 12 of the anode portion 1. In addition, the antenna 4 passes through a hole 15a provided in the pole piece 15 of the output side, and then passes through insides of the side pipe 31 and the antenna ceramic 32 to be extended to an inside of the exhaust pipe 33. The exhaust pipe 33 is made of copper, for example. The exhaust pipe 33 has a chip-off portion 33a. After gas in the anode portion 1, the cathode portion 2, and the output portion 3 is exhausted, the chip-off portion 33a is formed by being pressure-bonded with the antenna 4 interposed therein and removing an unnecessary portion. Microwave energy generated in the anode portion 1 is extracted from the anode portion 1 with the antenna 4 connected to the one of vanes 12 to be emitted outside from the chip-off portion 33a.

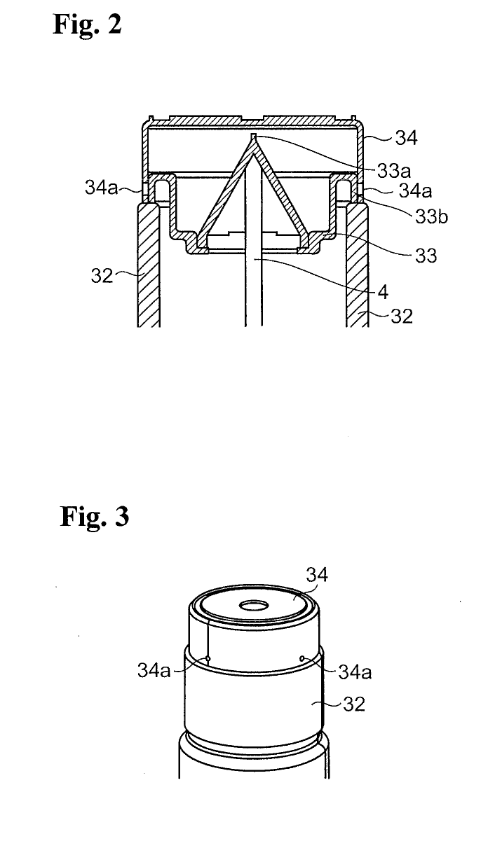

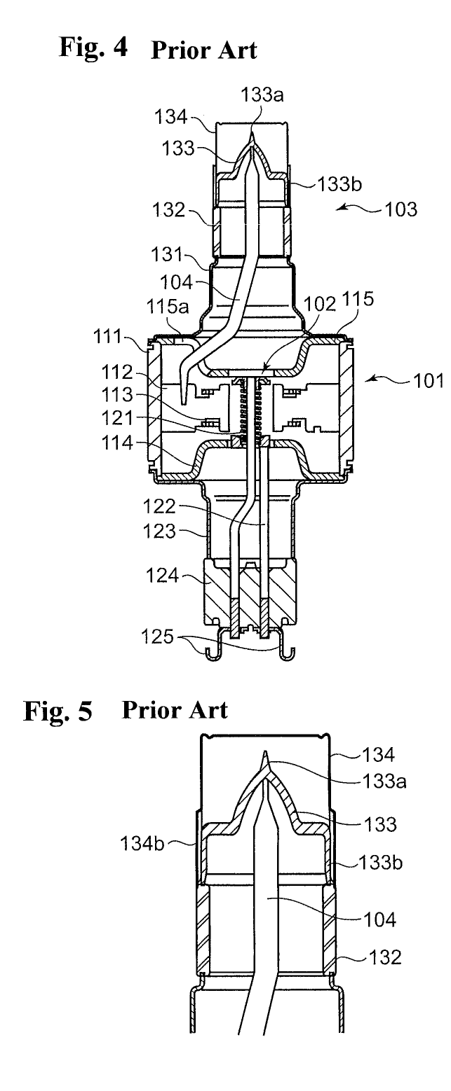

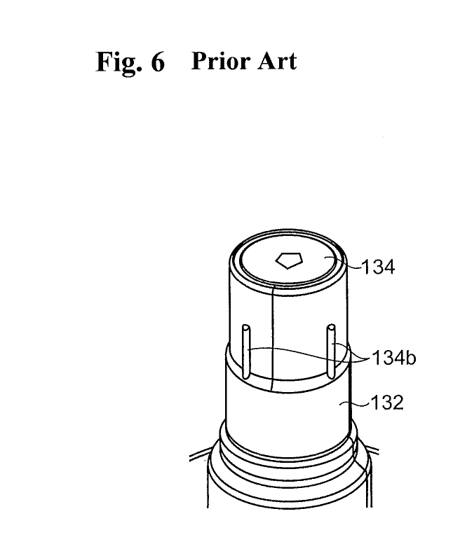

The chip-off portion 33a formed in an edge shape is a portion which is easily damaged. Accordingly, as shown in FIGS. 2 and 3, an antenna cap 34 is attached so as to cover the chip-off portion 33a. The antenna cap 34 is formed of stainless steel (SUS), for example. The antenna cap 34 is press-fitted to an outer circumferential surface of an end portion 33b serving as a connecting portion with the antenna ceramic 32 of the exhaust pipe 33, and is welded to the outer circumferential surface thereof. The magnetron according to this embodiment is a magnetron having an oscillation frequency of 5.8 GHz band. Therefore, as compared to a magnetron having an oscillation frequency of 2.45 GHz band, the length of the end portion (outer circumferential surface) 33a of the exhaust pipe 33 is short in the tubular axial direction (e.g., 5 mm).

In the magnetron according to this embodiment, the antenna cap 34 and the exhaust pipe 33 are welded to each other. Therefore, even if heat cycle is repeated by switching ON/OFF of the magnetron, it is possible to further reliably suppress removal of the antenna cap 34. In addition, even if the exhaust pipe 33 and the antenna ceramic 32 are formed of materials having different thermal expansion coefficients, and even if the end portion 33b of the exhaust pipe 33 is formed in a tapered shape, it is possible to further reliably suppress the removal of the antenna cap 34. It is also possible to suppress positional deviation between the antenna cap 34 and the exhaust pipe 33, so that the operation of the magnetron is stabilized.

It is preferable to form a hole 34a in a sidewall of the antenna cap 34, and to weld a peripheral portion of the hole 34a and the exhaust pipe 33. In this case, both of the antenna cap 34 and the exhaust pipe 33 are fused to facilitate forming of an alloy layer, so that a coupling strength between the antenna cap 34 and the exhaust pipe 33 can be enhanced.

Further, it is more preferable to form three or more holes 34a in the sidewall of the antenna cap 34 in an equal pitch, and to weld each peripheral portions of the holes 34a and the exhaust pipe 33. In this case, it is possible to further enhance the coupling strength between the antenna cap 34 and the exhaust pipe 33, and to suppress occurrence of electric discharge and vacuum leakage through a gap between the antenna cap 34 and the exhaust pipe 33.

From a viewpoint of preventing electric discharge and vacuum leakage, it is preferable that the antenna cap 34 is welded to the entire circumference of the outer circumferential surface of the exhaust pipe 33, but it is difficult to weld the entire circumference thereof. Accordingly, from a viewpoint of production stability, it is preferable that the antenna cap 34 and the exhaust pipe 33 are spot welded at approximately three to five points.

The foregoing description has been made of the magnetron having the oscillation frequency of 5.8 GHz band, but the magnetron according to the present invention is not limited thereto. The structure in which the antenna cap 34 and the exhaust pipe 33 are welded is also applicable to a magnetron having an oscillation frequency of another band (e.g., 2.45 GHz band), and provides an effect of suppressing removal of the antenna cap 34.

In addition, it is preferable that shapes of the inner circumferential surface of the antenna cap 34 and the outer circumferential surface of the exhaust pipe 33 match with each other. For example, it is preferable that the inner circumferential surface of the antenna cap 34 and the outer circumferential surface of the exhaust pipe 33 have a cylindrical shape. Accordingly, it is possible to suppress formation of a gap between the antenna cap 34 and the exhaust pipe 33, and therefore, suppress occurrence of failures, such as electric discharge, vacuum leakage, and the like, through the gap. In a conventional magnetron, as shown in FIG. 5, an end portion 133b of an exhaust pipe 133, to which an antenna cap 134 is press-fitted, has a long length in a tubular axial direction. Accordingly, when shapes of an inner circumferential surface of the antenna cap 134 and an outer circumferential surface of the exhaust pipe 133 are made to match with each other, it becomes difficult for the antenna cap 134 to be press-fitted to the outer circumferential surface of the exhaust pipe 133. Accordingly, the antenna cap 134 is provided with a plurality of concave portions 134b in the inner circumferential surface of the antenna cap 134 to facilitate press-fitting of the antenna cap 134 to the outer circumferential surface of the exhaust pipe 133. In this case, failures such as electric discharge, vacuum leakage, and the like may occur through the concave portions 134b.

Although the present invention has been fully described by way of preferred embodiment with reference to the accompanying drawings, it is to be noted that various changes and modifications will be apparent to those skilled in the art. Therefore, unless such changes and modifications otherwise depart from the scope of the present invention as recited in the attached claims, they should be construed as being included therein.

The entire disclosure of Japanese Patent Application No. 2013-001487 filed on Jan. 9, 2013, including specification, drawings, and claims is incorporated herein by reference in its entirety.

The magnetron according to the present invention can further reliably suppress removal of the antenna cap, and thus, is applicable not only to devices using microwaves for household use, such as a microwave oven, a convection microwave oven, and the like, but also to devices using microwaves for industrial use.

What is claimed is:

1. A magnetron comprising:
an anode portion, a cathode portion arranged in a central portion of the anode portion, an output antenna connected to the anode portion, an exhaust pipe arranged around the output antenna to serve as a part of a vacuum tube, and an antenna cap covering a chip-off portion included in the exhaust pipe, wherein
the antenna cap and the exhaust pipe are welded to each other.

2. The magnetron according to claim 1, wherein a sidewall of the antenna cap includes at least a hole, a peripheral portion of the hole and the exhaust pipe are welded.

3. The magnetron according to claim 1, wherein a sidewall of the antenna cap includes three or more holes arranged in an equal pitch, each peripheral portion of the holes in the antenna cap and the exhaust pipe are welded.

4. The magnetron according to claim 1, wherein the magnetron has an oscillation frequency of 5.8 GHz band.

5. The magnetron according to claim 4, wherein shapes of the inner circumferential surface of the antenna cap and the outer circumferential surface of the exhaust pipe match with each other.

6. The magnetron according to claim 4, wherein the inner circumferential surface of the antenna cap and the outer circumferential surface of the exhaust pipe have a cylindrical shape.

7. A device using microwaves comprising the magnetron according to claim 1.
